(19) United States
(12) Patent Application Publication
(10) Pub. No.: US 2006/0099025 A1
(43) Pub. Date: May 11, 2006

(54) Multi-surface paint roller

(76) Inventor: Kerry Hann, Ashland, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 10/981,126

(22) Filed: Nov. 4, 2004

(51) Int. Cl. B05C 17/02

(52) U.S. Cl. 401/197; 15/230.11; 15/230.18; 492/13; 492/19

(57) ABSTRACT

A paint roller includes multiple surfaces to apply paint to an uneven surface.

### CROSS REFERENCE TO RELATED APPLICATIONS

Not Applicable.

### STATEMENT REGARDING FEDERALLY SPONSORED RESEARCH

Not applicable.

### FIELD OF THE INVENTION

The present invention relates generally to painting and, more particularly to devices for painting structures having uneven surfaces.

### BACKGROUND OF THE INVENTION

As is known in the art, painting relatively large structures, such as a house, is a significant undertaking. Many houses are covered with clapboard type shingles. As is well known, clapboards are relatively long pieces of wood having a generally triangular cross-section that are secured to an exterior of the structure in an overlapping arrangement.

FIGS. 1 and 1A shows an exemplary prior art clapboard shingle surface 10. Each clapboard shingle 12 provides a sloped surface 14 and an under surface 16. While is relatively easy to brush or roll on paint along the sloped surface 14 in a horizontal direction, it is more time-consuming to ensure that the under surface 16 of each shingle is fully painted. When using a brush, for example, the painter should make specific efforts to paint the under surface. This multi-step process is quite time consuming. In addition, the under surface 16 is generally not visible to the painter so that considerable expertise may be required to consistently make sure that the entire under surface is fully painted with a brush.

### SUMMARY OF THE INVENTION

The present invention provides a multi-surface roller that is well suited to paint uneven surfaces, such as clapboard shingled structures. With this arrangement, the efficiency of the painting process is significantly enhanced. While the invention is primarily shown and described in conjunction with painting clapboard shingles, it is understood that the invention is applicable to painting a wide range of non-smooth surfaces.

In one aspect of the invention, a paint roller includes a first generally cylindrical surface to apply paint having a first circumference and a second generally cylindrical surface to apply paint, where the first circumference is greater than the second circumference. The roller further includes a third surface that transitions the first surface to the second surface.

In one particular embodiment, the first surface can apply paint to a sloped surface of a first clapboard shingle and the second surface can apply paint to a second clapboard shingle. The third surface is effective to apply paint to an underside of the second clapboard shingle.

### BRIEF DESCRIPTION OF THE DRAWINGS

The invention will be more fully understood from the following detailed description taken in conjunction with the accompanying drawings, in which:

FIG. 1A is a pictorial side view of a prior art surface defined by clapboard shingles covering a structure;

FIG. 1B is a pictorial front view of a prior art surface defined by clapboard shingles covering a structure;

FIG. 2 is a diagram of a multi-surface roller in accordance with the present invention;

FIG. 2A is a schematic representation of the roller of FIG. 2;

FIG. 2B is a further diagram of a multi-surface roller in accordance with the present invention;

FIG. 3 is a diagram of a multi-surface roller applying paint to a surface in accordance with the present invention;

FIG. 4 is a diagram of a further multi-surface roller applying paint to a surface in accordance with the present invention;

FIG. 5 is a partial cutaway view of a multi-surface roller in accordance with the present invention; and

FIG. 6 is a painting system including a multi-surface roller in accordance with the present invention.

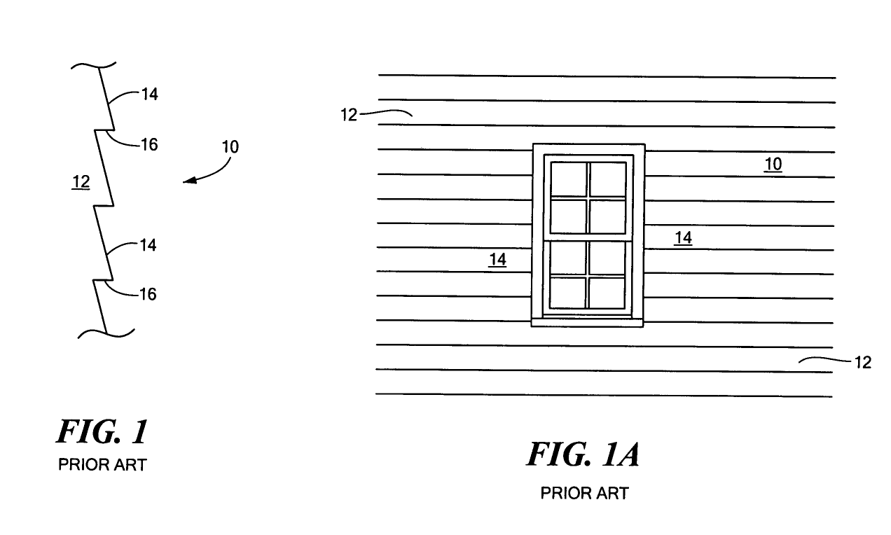

### DETAILED DESCRIPTION OF THE INVENTION

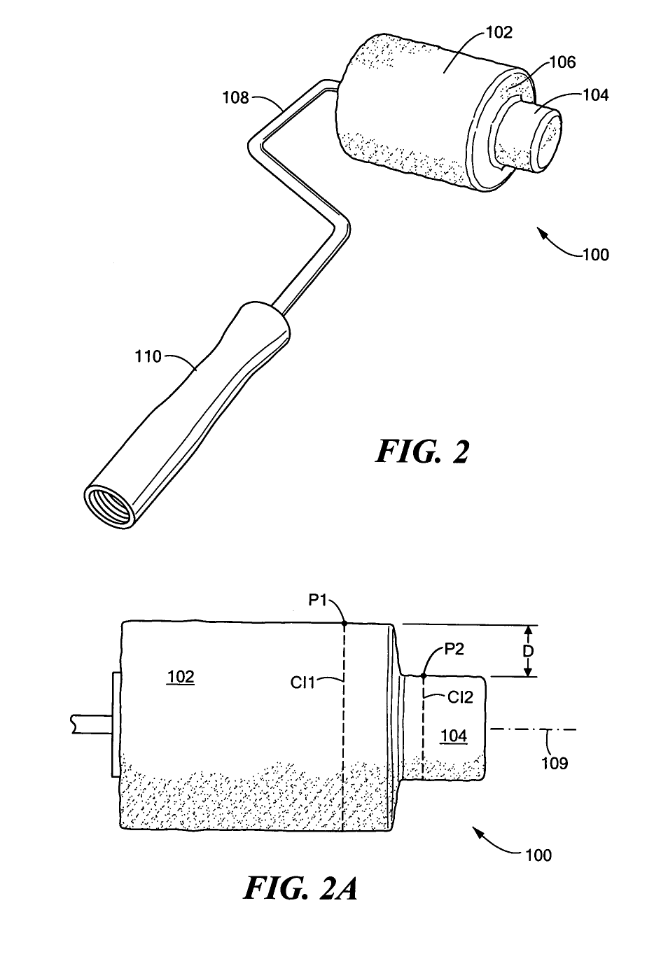

FIG. 2 shows a multi-surface roller 100 having a first surface 102 and a second surface 104. A third surface 106 provides a transition from the first surface 102 to the second surface 104. In an exemplary embodiment, the third surface 106 is effective to paint the under surface of a clapboard shingle, as described more fully below. The roller 100 can include a structural member 108 extending to a handle 110 in a conventional manner.

In general, as shown in FIG. 2A, the first surface 102 includes a first circumference C11 at a first point P1 and the second surface 104 includes a second circumference C12 at point P2 that is less than the first circumference. A distance D is defined as the difference between the first surface 102 and the second surface 104. The distance D can be measured proximate the third surface 106. In general, the distance D can range from about 0.25 inch to about 1.0 inch. In one embodiment, the distance D corresponds to the depth of a clapboard shingle under surface. The difference in the first and second circumferences can vary to meet the requirements of a particular application, which can depend upon the characteristics of the surface to be painted. It is understood that where one or both of the first and second surface 102, 104 are angled with respect to a longitudinal axis 109, the respective circumferences along the surfaces will vary.

In one particular embodiment, a nap of the roller surface between the first and second points 102, 104 is relatively short to minimize “catching” of the nap on the edge of a clapboard as the roller is moved horizontally. In an exemplary embodiment, the third surface 106 has some desired rigidity under the nap to help prevent non-horizontal movement of the roller. That is, without some rigidity under the third surface 106 there may be a tendency for a user to move the roller over clapboards in a non-horizontal direction instead of the desired horizontal movement along and parallel to the clapboards.

As shown in FIG. 2B, the roller 100′ can include multiple second surfaces 104a,b at each end of the first surface 102.

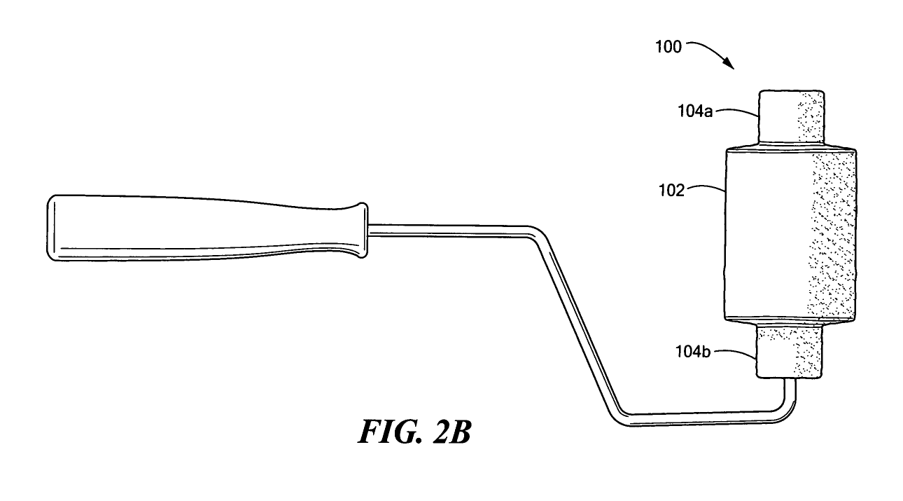

In one particular embodiment shown in FIG. 3, the first surface 102 of the roller is adapted to paint the sloped surface 14a of a first clapboard and the second surface 104 is adapted to paint the bottom-most part of the sloped surface 14b of a second clapboard above the first clapboard. The third surface 106 is adapted to paint the under surface 16 of the second clapboard.

In the applying paint to the under surface of a clapboard surface, the second surface 104 may be helpful in guiding a painter along horizontally but optional. The first and third surfaces 102, 106 are effective to apply paint to the sloped and under surfaces of the clapboard shingles.

With this arrangement, a painter can paint horizontally along the length of a clapboard shingle covering the sloped surface along with the under surface of the clapboard above. This particular structure eliminates or reduces efforts to specifically paint the under surfaces of the clapboard shingles, which saves a significant time and effort in comparison with conventional rollers.

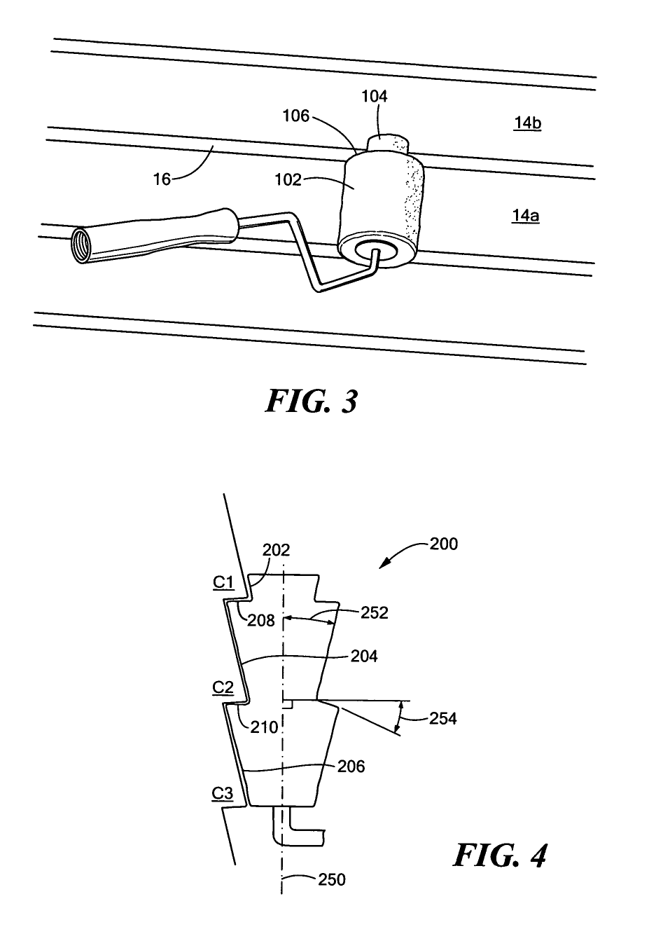

As shown in FIG. 4, a multi-surface roller 200 can include surfaces to cover multiple clapboard shingles, here shown as first, second and third clapboards C1, C2, C3, in a horizontal painting motion. In one embodiment, the roller 200 includes first, second, and third surfaces 202, 204, 206 to paint the sloped surfaces S1, S2, S3 of the respective clapboard shingles C1, C2, C3. The roller 200 also includes fourth and fifth, and surfaces 208, 210 to paint the under surfaces U1, U2, U3 of the clapboard shingles.

It is understood that the particular angles of the roller surfaces with respect to a longitudinal axis 250 of roller can vary. In addition, it should be understood that angles are approximate in view of the “give” provided by the roller surface.

An exemplary range for the angle of roller surfaces adapted to paint the sloped surface of a clapboard shingle or other such structure, such as the angle 252 of surface 202, can vary from about −20 degrees to about 50 degrees. An exemplary range for the angle of roller surfaces adapted to paint the under surface of a clapboard shingle or other structure, such as the angle 254 of surface 210, can vary from about plus/minus 45 degrees with respect to perpendicular to the axis 250. In one embodiment, this angle ranges from about plus to minus ten degrees to effectively paint the clapboard under surface.

It is understood that the surface contours and dimensions of the roller can be selected to complement a particular surface. While the invention is primarily shown and described in conjunction with painting clapboard surfaces, it is understood that the invention is applicable to a wide variety of uneven surfaces.

In one embodiment, the distance between surfaces to paint the sloped clapboard surfaces can range from about 0.25 inch to about 1.0 inch. It is understood however that other dimensions are possible for optimal application of paint to a surface having particular geometries.

The roller can be fabricated from a variety of materials and techniques well known to one of ordinary skill in the art. In general, the roller includes an outer surface that can be provided by conventional materials used for rollers. The material should be absorbent to hold paint from a reservoir that is then applied to the target surface. Under the outer roller material can be disposed a semi-rigid material, secured to a generally rigid material that can be cylindrically shaped. A variety of suitable semi-rigid materials will be readily known by one of ordinary skill in the art. A handle can be removably attached to the rigid cylinder in a manner well known in the art. The particular structure and layering of materials can be readily selected by one of ordinary skill in the art to provide the desired roller surface contour and dimensions.

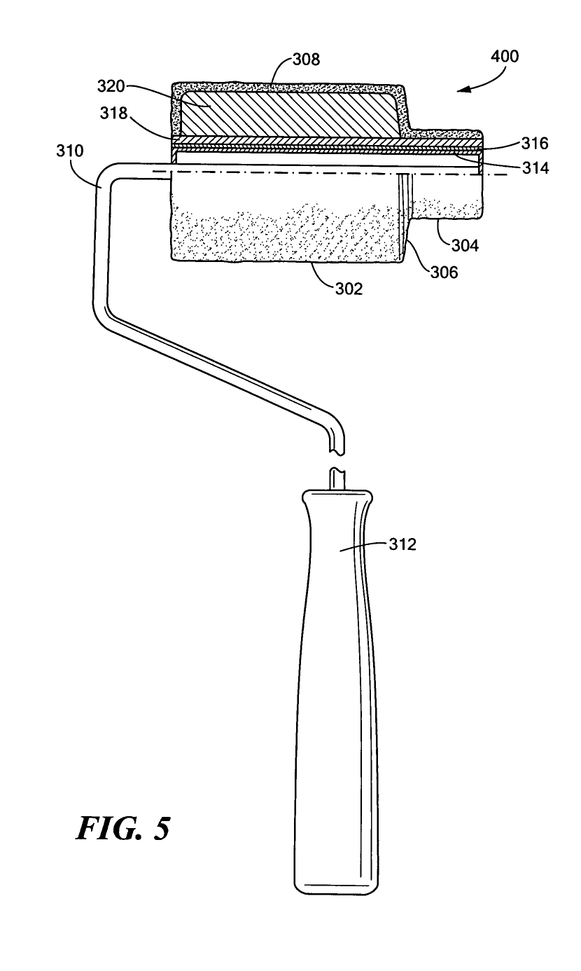

FIG. 5 shows an exemplary structure for a multi-surface roller 300 in accordance with the present invention. The roller 300 is shown in partial cut-away, with the upper half shown with one quarter of the cylinder cut away. In one particular embodiment, a first surface 302, second surface 304 and third surface 306 is provided as a contiguous outer surface material 308 well suited to apply paint. A structural member 310, which can extend to a handle 312, is secured to a rigid tube 3 14 in a conventional manner. The tube 314, which can be formed from PVC for example, can be forcibly inserted into complementary cylinder 3 16. A first semi-rigid material 318 can be secured about the cylinder 316.

The outer surface material 308 can be secured to the first semi-rigid material 318 at locations generally corresponding to a length of the second surface 304, which has a smaller circumference than the first surface 302. A second semi-rigid material 320 can be secured to a portion of the first semi-rigid material 318 along a length generally corresponding to the first surface 302, which has a greater circumference than the second surface 304.

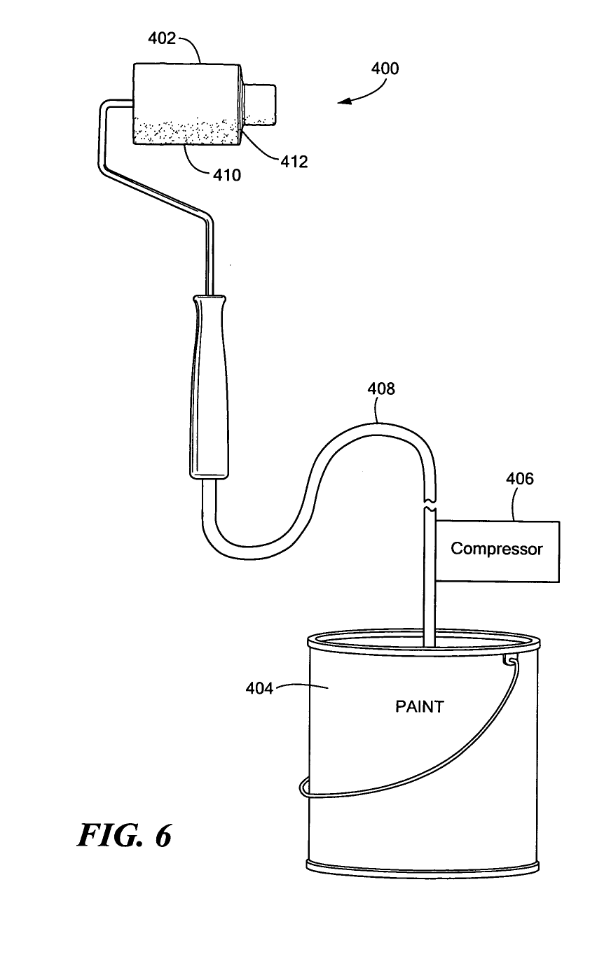

FIG. 6 shows an exemplary painting system 400 including a multi-surface roller 402 coupled to a paint supply 404, which can be provided in a paint can. A compressor 406 is coupled to the supply line to generate a steady stream of paint for application to a structure in a manner well known to one of ordinary skill in the art. As described above, the roller 402 can include at least a first surface 410 to paint a first surface, such as the sloped surface of a clapboard shingle, and a second surface 412, to paint a second surface, such as the under surface of a clapboard shingle.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A paint roller, comprising:
a first generally cylindrical surface to apply paint, the first surface having a first circumference at a first point;
a second generally cylindrical surface to apply paint, the second surface having a second circumference at a second point, wherein the first circumference is greater than the second circumference; and
a third surface that transitions the first surface to the second surface, the third surface to apply paint.

2. The roller according to claim 1, wherein the first and second surfaces are generally parallel.

3. The roller according to claim 1, further including a longitudinal axis, wherein the first surface is angled with respect to the longitudinal axis.

4. The roller according to claim 1, wherein the first, second, and third surfaces are formed from a single material.

5. The roller according to claim 1, wherein the third surface is adapted to apply paint to an under surface of a first clapboard shingle.

6. The roller according to claim 5, wherein the first surface is adapted to apply paint to a sloped surface of a second clapboard shingle adjacent to the first clapboard shingle.

7. A paint roller, comprises:
a first surface to paint a sloped region of a first clapboard shingle;
a second surface to paint a portion of a second clapboard shingle adjacent to the first clapboard shingle; and
a third surface between the first and second surfaces to paint an under surface of the second clapboard shingle.

8. The roller according to claim 7, wherein the first and third surfaces are generally parallel.

9. The roller according to claim 7, wherein the first surface has a length generally corresponding to the sloped region of the first clapboard shingle.

10. The roller according to claim 7, wherein the roller has a longitudinal axis and the first surface forms an angle with the longitudinal axis between about −20 degree to about 50degrees.

11. The roller according to claim 7, wherein a distance between the first and third surfaces ranges from about 0.25 inch to about 1.0 inch.

12. The roller according to claim 1, wherein the roller is coupled to a pressurized paint system.

13. A method of painting, comprising:
applying paint to a clapboard shingle covered house using a roller having:
a first surface to paint a sloped region of a first clapboard shingle;
a second surface to paint a portion of a second clapboard shingle adjacent to the first clapboard shingle; and
a third surface between the first and second surfaces to paint an under surface of the second clapboard shingle.

14. The method according to claim 13, wherein the first and third surfaces are generally parallel.

15. The method according to claim 13, wherein the first surface has a length generally corresponding to the sloped region of the first clapboard shingle.

16. The method according to claim 13, wherein the roller has a longitudinal axis and the first surface forms an angle with the longitudinal axis between about −20 degree to about 50 degrees.

17. The method according to claim 13, wherein a distance between the first and third surfaces ranges from about 0.25 inch to about 1.0 inch.

18. The method according to claim 3, wherein the roller is coupled to a pressurized paint system.
